(19) United States
(12) Patent Application Publication
(10) Pub. No.: US 2023/0351066 A1
(43) Pub. Date: Nov. 2, 2023

(54) METHOD AND PROGRAM FOR AUTOMATICALLY ARRANGING PARTS ON CAD

(71) Applicant: Mitsubishi Electric Corporation, Tokyo (JP)

(72) Inventors: Katsumi URYU, Fukuoka (JP); Koji OKUNO, Tokyo (JP); Noritsugu NOMURA, Tokyo (JP)

(73) Assignee: Mitsubishi Electric Corporation, Tokyo (JP)

(21) Appl. No.: 18/059,612

(22) Filed: Nov. 29, 2022

(30) Foreign Application Priority Data
Apr. 27, 2022 (JP) 2022-073231

(51) Int. Cl. G06F 30/12

(52) U.S. Cl. CPC G06F 30/12

(57) ABSTRACT

A method for automatically arranging parts on a CAD comprises: part condition acquisition step A; part arrangement order acquisition step; boundary line acquisition step B; part arrangement step C; boundary line updating step; first repetition step; part type change step; and second repetition step. In step A, part boundary condition, set for each of types of parts, representing the type of the part to be permitted to be arranged adjacent to the part is acquired. In step B, boundary line boundary condition to be set for a boundary line parallel to an area termination end line of an arrangement area in X- or Y-direction is acquired. In step C, the part boundary condition set for the part and the boundary line boundary condition set for the boundary line arranged in the arrangement area are compared with each other, and the part is arranged when the conditions match each other.

### FIELD

The present disclosure relates to a method and a program for automatically arranging parts on a CAD, and more specifically a method and a program for automatically arranging a plurality of types of parts constituting a semiconductor chip in a semiconductor chip arrangement area.

### BACKGROUND

In processes for manufacturing a semiconductor device, a photolithographic technique is used to transfer a pattern onto a semiconductor substrate. In the photolithographic technique, a photosensitive material applied onto the semiconductor substrate is irradiated with light through a photomask. A pattern of a semiconductor chip is drawn on the photomask. A CAD device also referred to as a CAD tool is used to manufacture the photomask. CAD drawings, which are created using the CAD device, of the photomask have a hierarchical structure. That is, a file where a plurality of types of parts constituting the semiconductor chip are arranged and a file where each of various types of parts is drawn are separated so that an entire image of the semiconductor device can be easily managed.

A power device has been known as a semiconductor device for power control. In the power device, many transistors referred to as cells are arranged to be connected in parallel to control a large current. The number of arrangements of cells ranges to several millions, for example. In the CAD drawings for the power device, parts are arranged without any gap therebetween in a semiconductor chip arrangement area. The arrangement of the parts in position without any gap therebetween is implemented by automatic arrangement of the parts on a drawing surface of the CAD device.

Patent Literature 1 discloses a method for automatically designing a semiconductor integrated circuit.

### CITATION LIST

### Patent Literature

Patent Literature 1: JP 2016-105234 A

### SUMMARY

### Technical Problem

A map system may be adopted as a method for automatically arranging parts. In the map system, after reading an arrangement map into a program, as illustrated in FIG. 34, a chip size of a semiconductor chip is adjusted by providing a region where there are provided parts constituting the semiconductor chip, which are referred to as fixed parts PTfx, and a dimension adjustment region indicated by hatching in the drawing where there are provided adjustment parts PTaj. In the map system, the fixed parts PTfx and the adjustment parts PTaj need to be identified, whereby a number of conditions (also referred to as an amount of conditions) to be set by a user increases. Even when the parts PTfx of the same type are arranged, coordinate setting corresponding to the parts is required. Even when an array is used, the number of vertical and horizontal arrays needs to be set. Rotation/inversion setting is associated with coordinates. Accordingly, even when the same fixed parts PTfx are arranged at each of four corners indicated by R1 in the figure, the number of conditions to be set by the user increases when a rotation/inversion direction differs for each of the coordinates.

As another automatic arrangement method, a free arrangement system for freely arranging parts without using a map may be adopted. In the free arrangement system, to identify that parts have not yet been arranged or that parts have arranged, arrangement coordinates are previously set by providing a mesh Ms as illustrated in FIG. 35, for example. However, the size of a semiconductor chip for power device ranges to several centimeters, while a spacing between the arrangement coordinates is 0.1 μm or less. In this case, 10¹⁰ or more arrangement coordinates need to be set in the mesh Ms. Accordingly, a calculation load including a memory capacity increases for the CAD device.

The present disclosure has been made to solve the above-described problems, and is directed to providing a method and a program for automatically arranging semiconductor chip parts having a small number of conditions to be set by a user and having a small calculation load.

### Solution to Problem

A method for automatically arranging parts on a CAD according to the present disclosure is the method for automatically arranging a plurality of types of parts in an arrangement area on a CAD tool. Two directions perpendicular to each other in the arrangement area are an X-direction and a Y-direction, and the plurality of types of parts are each a rectangle having a side parallel to the X-direction or the Y-direction. The method for automatically arranging parts on a CAD, comprising: a part condition acquisition step for acquiring a part boundary condition, which is set for each of the types of the parts, representing the type of the part to be permitted to be arranged adjacent to the part; a part arrangement order acquisition step for acquiring an arrangement order, which is set for each of the types of the parts, of the part in the arrangement area; a boundary line acquisition step for arranging a boundary line parallel to an area termination end line as a line representing a termination end of the arrangement area in the X-direction or the Y-direction and acquiring a boundary line boundary condition representing the parts arranged in two regions separated by the boundary line; a part arrangement step for comparing the part boundary condition set for the part and the boundary line boundary condition set for the boundary line arranged in the arrangement area and arranging the part when the conditions match each other; a boundary line updating step for updating the boundary line and the boundary line boundary condition after arranging the part in the part arrangement step; a first repetition step for repeatedly performing the part arrangement step and the boundary line updating step; a part type change step for changing, when the part boundary condition and the boundary line cannot match each other, the type of the part to be arranged to the part to be arranged next in order; and a second repetition step for repeatedly performing the part arrangement step, the boundary line updating step, the first repetition step, and the part type change step according to the arrangement order.

A program for automatically arranging parts on a CAD according to the present disclosure is the program for automatically arranging a plurality of types of parts in an arrangement area on a CAD tool. Two directions perpendicular to each other in the arrangement area are an X-direction and a Y-direction, and the plurality of types of parts are each a rectangle having a side parallel to the X-direction or the Y-direction. The program for automatically arranging causes a computer to perform: a part condition acquisition step for acquiring a part boundary condition, which is set for each of the types of the parts, representing the type of the part to be permitted to be arranged adjacent to the part; a part arrangement order acquisition step for acquiring an arrangement order, which is set for each of the types of the parts, of the part in the arrangement area; a boundary line acquisition step for arranging a boundary line parallel to an area termination end line as a line representing a termination end of the arrangement area in the X-direction or the Y-direction and acquiring a boundary line boundary condition representing the parts arranged in two regions separated by the boundary line; a part arrangement step for comparing the part boundary condition set for the part and the boundary line boundary condition set for the boundary line arranged in the arrangement area and arranging the part when the conditions match each other; a boundary line updating step for deleting the boundary line that overlaps a side of the part arranged in the part arrangement step and setting the new boundary line and the boundary line boundary condition on the side of the part that does not overlap the boundary line; a first repetition step for repeatedly performing the part arrangement step and the boundary line updating step; a part type change step for changing, when the part boundary condition and the boundary line cannot match each other, the type of the part to be arranged to the part to be arranged next in order; and a second repetition step for repeatedly performing the part arrangement step, the boundary line updating step, the first repetition step, and the part type change step according to the arrangement order.

### Advantageous Effects of Invention

According to the present disclosure, since parts are automatically arranged using a boundary condition, the number of conditions to be set by a user can be reduced. Moreover, it can be identified that the part has not yet been arranged or that the part has using not a mesh but a boundary line. Accordingly, a calculation load, including reduction of a memory, can be small.

### BRIEF DESCRIPTION OF THE DRAWINGS

FIG. 1 is a schematic diagram to explain boundary conditions set for a part arranged by a method for automatically arranging semiconductor chip parts according to a first embodiment.

FIG. 2 is a schematic diagram to explain a semiconductor chip arrangement area in which parts are arranged by a method for automatically arranging semiconductor chip parts according to a first embodiment.

FIG. 3 is a schematic diagram for showing an example of offset arrangement of the part.

FIG. 4 is a schematic diagram showing an arrangement example of parts.

FIG. 5 is a schematic diagram showing an arrangement example of parts.

FIG. 6 is a schematic diagram showing an arrangement example of a part when XY-coordinates are designated by a user.

FIG. 7 is a schematic diagram showing an arrangement example of a part when X-coordinate or Y-coordinate is designated by a user.

FIGS. 8A and 8B are schematic diagrams showing arrangement examples of part.

FIGS. 9A to 9D are schematic diagrams showing arrangement examples of parts.

FIGS. 10A to 10D are schematic diagrams showing arrangement examples of parts.

FIGS. 11A to 11C are schematic diagrams showing candidates of a boundary condition group matched with boundary condition of part PTa.

FIGS. 12A to 12C are schematic diagrams to explain updating of the boundary line.

FIG. 13 is a schematic diagram showing a case of restricting a provisional arrangement area At.

FIGS. 14A to 14C are schematic diagrams to explain stretching of part.

FIGS. 15A and 15B are schematic diagrams to explain synchronizing of part.

FIGS. 16A and 16B are schematic diagrams showing arrangement examples of blocks in which parts are arranged.

FIG. 17 is a schematic diagram showing a master mask arrangement example of parts.

FIG. 18 is a schematic diagram showing a case where the arrangement area is a polygon.

FIGS. 19A to 19C are schematic diagrams showing examples of obtaining a blank area after or during arrangement of parts.

FIG. 20 is a hardware configuration diagram of a CAD device that performs the method for automatically arranging semiconductor chip parts according to the first embodiment.

FIG. 21 is a flowchart illustrating main processing of the method for automatically arranging parts on a CAD according to the first embodiment.

FIG. 22 is a flowchart illustrating initialization processing.

FIG. 23 is a flowchart illustrating arrangement option processing.

FIG. 24 is a flowchart illustrating boundary arrangement processing.

FIG. 25 is a flowchart illustrating boundary line evaluation processing.

FIG. 26 is a flowchart illustrating arrangement processing.

FIG. 27 is a flowchart illustrating provisional arrangement pre-processing.

FIG. 28 is a flowchart illustrating coordinate arrangement processing.

FIG. 29 is a flowchart illustrating line arrangement processing.

FIG. 30 is a flowchart illustrating provisional arrangement post-processing.

FIG. 31 is a flowchart illustrating completion processing.

FIG. 32 is a flowchart illustrating main processing of the method for automatically arranging parts on a CAD according to a modification.

FIG. 33 is a flowchart illustrating parts candidate extraction processing.

FIG. 34 is a schematic diagram to explain an automatically arrangement example of parts using a map system.

FIG. 35 is a schematic diagram an example of a mesh used in a free arrangement system.

### DESCRIPTION OF EMBODIMENT

An embodiment will be described below with reference to the drawings. Common or corresponding elements in the drawings are each assigned the same reference numerals, and hence description is simplified or omitted.

### First Embodiment

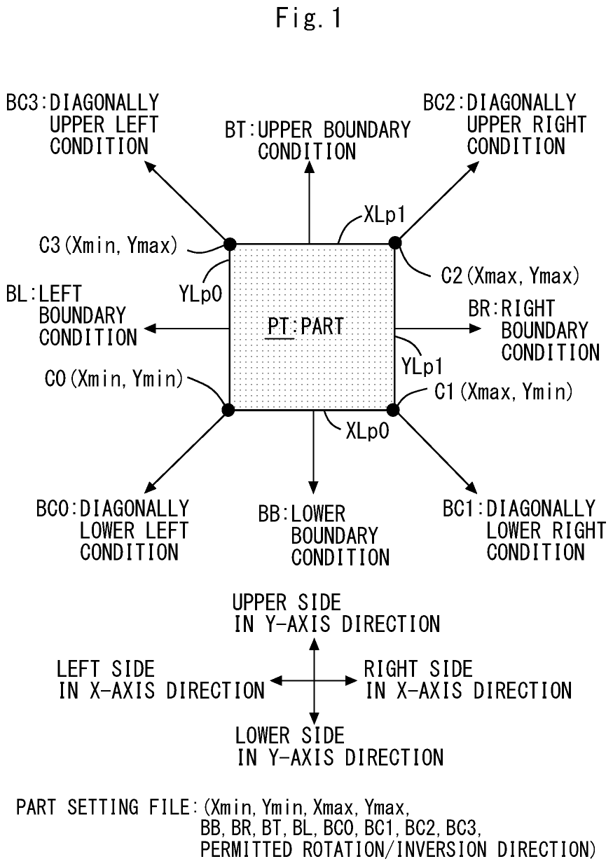

A method for automatically arranging semiconductor chip parts according to a first embodiment will be described using as an example a case where a plurality of types of parts are arranged in a semiconductor chip arrangement area AC to be set inside a dicing line DL with reference to FIGS. 1 to 31. In the following description, two directions perpendicular to each other in the arrangement area AC are set as an X-direction and a Y-direction. In FIG. 1, the left side, the right side, the upper side, and the lower side are respectively set as the left side in the X-direction, the right side in the X-direction, the upper side in the Y-direction, and the lower-side in the Y-direction. Various types of parts are each a rectangle having four sides XLp0, YLp1, XLp1, and YLp0 parallel to the X-direction or the Y-direction. The rectangle includes both a rectangle and a square.

(Preliminary Preparation by User)

Before performing the method for automatically arranging semiconductor chip parts, a user prepares a part CAD file, a part setting file, and a command file, and a stretch setting file described below, if necessary. These files are recorded in a memory 100b of a CAD device 1, described below.

The part CAD file is a file on which various types of parts PT to be arranged are drawn.

The part setting file is created for each type of part PT to correspond to the part CAD file. The part setting file includes first boundary conditions BB, BR, BT, and BL to be respectively set for all the sides XLp0, YLp1, XLp1, and YLp0 of the part PT, second boundary conditions BC0, BC1, BC2, and BC3 to be set for each of all corners C0 to C3, and a rotation condition representing a rotational angle to be permitted when the part PT is arranged in addition to coordinates Xmin, Ymin, Xmax, and Ymax of the part PT, as illustrated in FIG. 1. The first boundary conditions, the second boundary conditions, and the rotation condition to be set for the part RT are collectively referred to as a part boundary condition.

The first boundary condition represents the type of the part PT to be permitted to be arranged adjacent to each of the sides XLp0, YLp1, XLp1, and YLp0 parallel to the X-direction or the Y-direction. The second boundary condition represents the type of the part PT to be permitted to be arranged diagonally adjacent to each of the corners C0 to C3. The type of the part PT also includes being unable to be adjacently arranged. The part boundary condition is a boundary condition required to arrange the part PT, and a boundary condition after arrangement of the part PT need not be set.

When a condition to be set for the lower side XLp0 is described as an example of the first boundary condition, the part PT cannot be adjacently arranged because it overlaps the part PT itself on the upper side in the Y-direction of the lower side XLp0. On the other hand, the part PT is permitted to be adjacently arranged on the lower side in the Y-direction of the lower side XLp0. Accordingly, the lower boundary condition BB is set as the first boundary condition for the lower side XLp0. Similarly, the right boundary condition BR is set for the right side YLp1, the upper boundary condition BT is set for the upper side XLp1, and the left boundary condition BL is set for the left side YLp0.

when a condition to be set for the lower left corner C0 is described as an example of the second boundary condition, the part PT is permitted to be adjacently arranged diagonally downward to the left on the opposite side to the upper right corner C2 in a direction diagonal to the upper right corner C2 diagonally opposing the lower left corner C0. Accordingly, as the second boundary condition for the lower left corner C0, the diagonally lower left boundary condition BC0 is set. Similarly, the diagonally lower right boundary condition BC1 is set for the lower right corner C1, the diagonally upper right boundary condition BC2 is set for the upper right corner C2, and the diagonally upper left boundary condition BC3 is set for the upper left corner C3.

A rotational angle is set as the rotation condition. The rotational angle can be represented by a multiple of 90 degrees, for example, in a clockwise direction or a counterclockwise direction. In the map system already described, three conditions, i.e., an X coordinate and a Y coordinate as arrangement coordinates and a rotational angle need to be set for each corner, and the number of conditions to be set by a user is 12 when parts PT are each arranged at four corners. On the other hand, in the present embodiment, the number of conditions to be set by the user may be a total of three, that is, the conditions are two first boundary conditions and one rotation condition.

In a command file, commands such as a chip drawing size, an arrangement order of parts, a boundary line, an arrangement option, and a region designation are set. The commands can be described using a program language with which the CAD device 1, described below, is equipped.

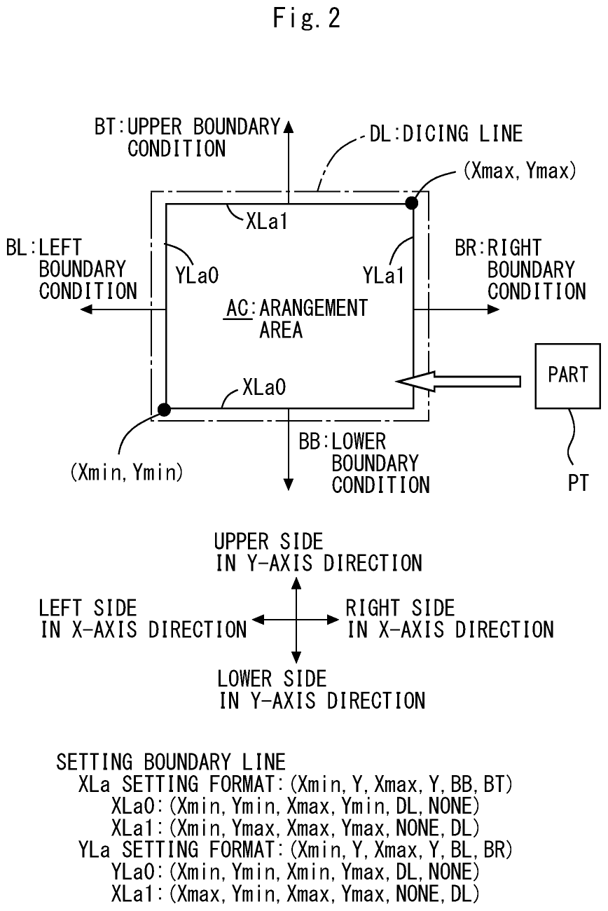

The chip drawing size is lengths in the X-direction and the Y-direction of an arrangement area AC where a plurality of types of parts PT constituting a semiconductor chip are arranged, as illustrated in FIG. 2. The arrangement order of the types of the parts can be set to an arrangement order from the part of a large size to the part of a small size or set based on a function of the part, for example. As the boundary line, four boundary lines XLa0, YLa1, XLa1, and YLa0 arranged parallel to an area termination end line as a line representing a termination end of the arrangement area AC, i.e., the dicing line DL in the X-direction or the Y-direction are set. For each of the boundary lines XLa0, YLa1, XLa1, and YLa0, a third boundary condition indicating that two regions separated by the boundary line are outside of the arrangement area of the parts PT is set. The third boundary condition is also referred to as a boundary line boundary condition. When the boundary line XLa1 on the upper side in a Y-axis direction is described as an example, the dicing line DL is arranged as initialization in the region on the upper side out of the regions on the upper side and the lower side separated by the boundary line XLa1. Thus, the region on the upper side of the boundary line XLa1 is a region where the parts PT cannot be arranged, i.e., outside of the arrangement area. Accordingly, the upper boundary condition BT is set as the third boundary condition for the boundary line XLa1. Similarly, the lower boundary condition BB is set for the boundary line XLa0, the right boundary condition BR is set for the boundary line YLa1, and the left boundary condition BL is set for the boundary line YLa0. The third boundary condition also referred to as the boundary line boundary condition may represent the presence or absence and the type of the parts PT arranged in the two regions separated by the boundary line.

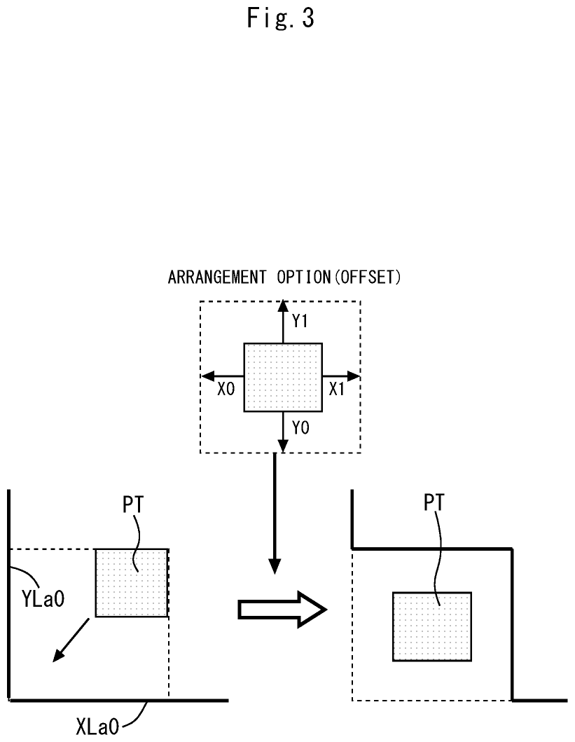

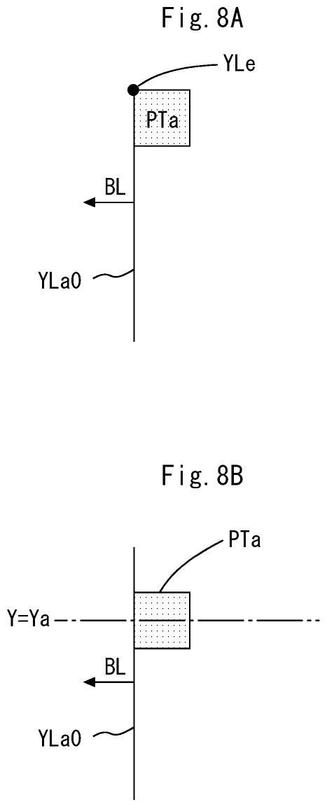

The arrangement option includes a coordinate arrangement option, a line arrangement option, an offset arrangement option, and the like. In the coordinate arrangement option, two coordinates (X and Y coordinates) in which a part is arranged are described. In the line arrangement option, a line end YLe at which a part is arranged (see FIG. 8A) and one coordinate out of an X-coordinate (X=Xa) and a Y-coordinate (Y=Ya) (see FIG. 8B) are described. In the line offset arrangement option, offset amounts X0, X1, Y0, and Y1 in the X-direction and the Y-direction as gaps between the part PT and boundary lines, for example, are described. Although in the present embodiment, it is assumed that a plurality of types of parts are arranged without any gap therebetween, i.e., each of the parts is arranged adjacent to the boundary lines, the present invention is not limited to this. A part can also be deliberately offset-arranged with gaps from boundary lines, as illustrated in FIG. 3, for example, depending on a device. Alternatively, an arrangement position of one part can also be shifted from a boundary line on which the other part is arranged.

When the parts PT are automatically arranged on a drawing surface of the CAD device 1 as a CAD tool, a part CAD file, a part setting file, a command file, and a stretch setting file preliminarily prepared by the user are read out from the memory 100b in the CAD device 1, and are acquired (a part condition acquisition process, a part arrangement order acquisition process, and a boundary line acquisition process).

The CAD device 1 can also create a part setting film from a CAD file where parts have already been arranged in the past. In this case, the CAD device 1 needs to be configured to be able to acquire a name or a type of the part PT, arrangement coordinates of the part, rotation/inversion information, stretch information, and size information of the part.

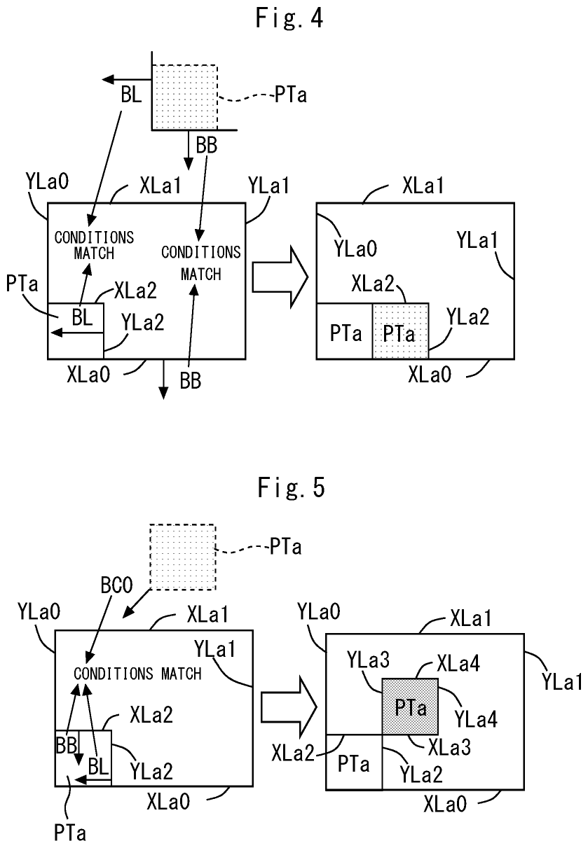

Then, parts are automatically arranged by the following procedure (a part arrangement process). That is, in the part arrangement process, a part boundary condition set for the part of a first type (hereinafter also merely referred to as “part”) PTa arranged in the preceding order and a boundary line boundary condition set for a boundary line arranged in the arrangement area AC are compared with each other. Specifically, a first boundary condition and a second boundary condition set for the part PTa and a third boundary condition set for the boundary line are compared with each other. A case where the same type of part PTa has already been arranged in the arrangement area AC will be described as an example. As a matching condition of boundary conditions under which the part PTa can be arranged, examples illustrated in FIGS. 4 to 8 can be listed.

In the example illustrated in FIG. 4, first boundary conditions BB and BL set for the part PTa respectively match a third boundary condition BB set for a boundary line XLa0 and a third boundary condition BL set for a boundary line YLa2. Accordingly, the part PTa is arranged to contact the two boundary lines XLa0 and YLa2.

In the example illustrated in FIG. 5, a second boundary condition BC0 set for the part PTa matches (substantially matches) third boundary conditions BL and BB respectively set for two boundary lines YLa2 and XLa2. Accordingly, the part PTa is arranged to contact a vertex formed between the two boundary lines YLa2 and XLa2.

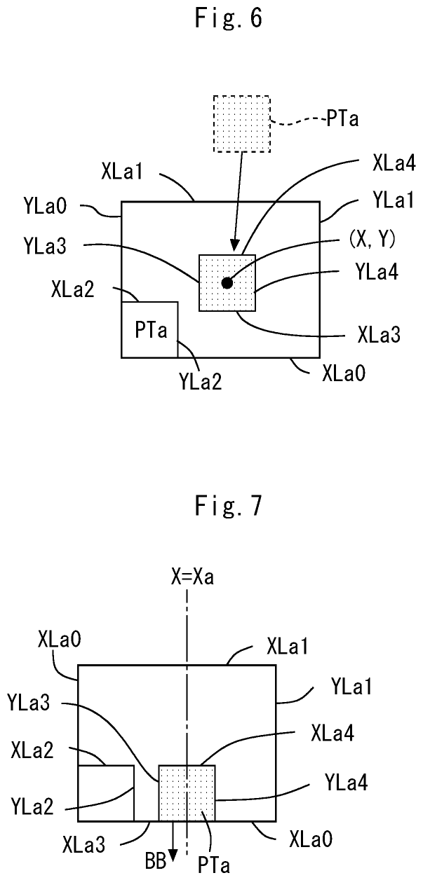

In the example illustrated in FIG. 6, the user designates XY-coordinates using a coordinate arrangement option as the arrangement option. In this case, the part PTa is offset arranged in designated coordinates (X, Y).

In the example illustrated in FIG. 7, a first boundary condition BB set for the part PTa matches a third boundary condition BB set for one boundary line XLa0, and the user designates an X-coordinate (X=Xa). In this case, the part PTa is arranged in contact with the boundary line XLa0 and in the designated X-coordinate (X=Xa). Similarly when a Y-coordinate is designated instead of the X-coordinate, the part PTa can be arranged.

In the example illustrated in FIG. 8A, a first boundary condition BL set for the part PTa matches a third boundary condition BL set for one boundary line YLa0, and the user designates a line end YLe using a line arrangement option as the arrangement option. In this case, the part PTa is arranged in contact with the boundary line YLa0 and at the designated line end YLe. In the example illustrated in FIG. 8B, a first boundary condition BL set for the part PTa matches a third boundary condition BL set for one boundary line YLa0, and the user designates a Y-coordinate (Y=Ya) using a line arrangement option as the arrangement option. In this case, the part PTa is arranged in contact with the boundary line YLa0 and in the designated Y-coordinate (Y=Ya).

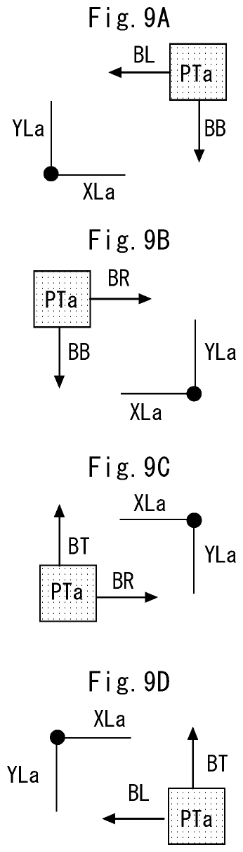

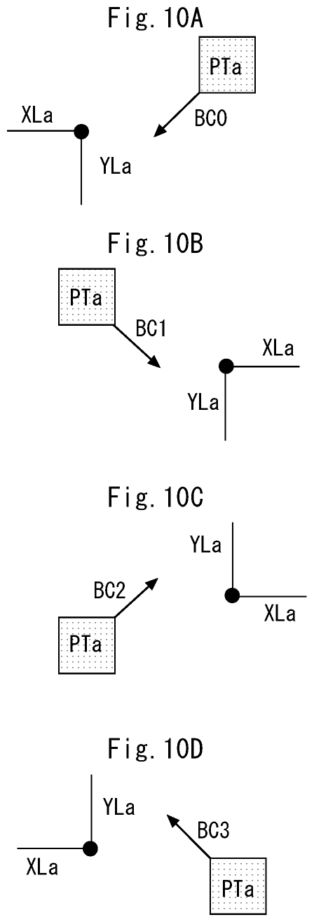

When boundary conditions set for the part PTa and the two boundary lines XLa and YLa match each other, arrangement of the part PTa can be classified into eight types illustrated in FIGS. 9A to 10D depending on a location of boundaries that match each other. A pattern where the part PTa can be arranged differs depending on a part boundary condition set for the part PTa.

In an example illustrated in FIG. 9A, a minimum value Xmin of the boundary line XLa and a minimum value Ymin of the boundary line YLa match each other. In an example illustrated in FIG. 9B, a maximum value Xmax of the boundary line XLa and a minimum value Ymin of the boundary line YLa match each other. In an example illustrated in FIG. 9C, a maximum value Xmax of the boundary line XLa and a maximum value Ymax of the boundary line YLa match each other. In an example illustrated in FIG. 9D, a minimum value Xmin of the boundary line XLa and a maximum value Ymax of the boundary line YLa match each other. In an example illustrated in FIG. 10A, a maximum value Xmax of the boundary line XLa and a maximum value Ymax of the boundary line YLa match each other. In an example illustrated in FIG. 10B, a minimum value Xmin of the boundary line XLa and a maximum value Ymax of the boundary line YLa match each other. In an example illustrated in FIG. 10C, a minimum value Xmin of the boundary line XLa and a minimum value Ymin of the boundary line YLa match each other. In an example illustrated in FIG. 10D, a maximum value Xmax of the boundary line XLa and a minimum value Ymin of the boundary line YLa match each other.

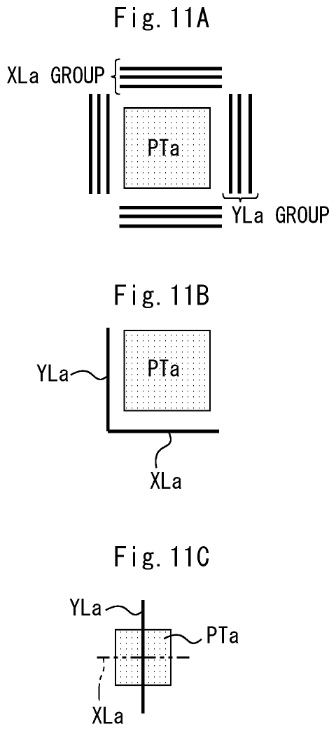

It is examined which of the arrangement patterns is possible from the first boundary condition or the third boundary condition set for the part PTa, to perform the following operation for each of the possible arrangement patterns. That is, candidates for an XLa group and a YLa group that match the part boundary condition for the part PTa are first searched for, as illustrated in FIG. 11A. Then, when start points and end points of each of the boundary lines XLa and YLa match those in the examples illustrated in FIGS. 9A to 10D, as illustrated in FIG. 11B, an arrangement of the part PTa is possible. As illustrated in FIG. 11C, when the boundary lines YLa or XLa exists in the part PTa, the arrangement of the part PTa is stopped.

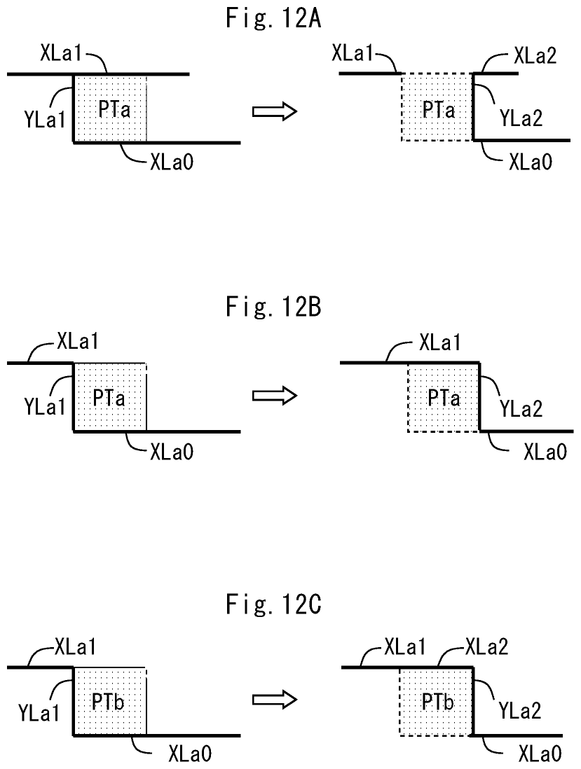

When the arrangement of the part PTa is finished, a boundary line newly created by the arrangement of the part PTa is evaluated, to update the boundary line, as illustrated in FIGS. 12A to 12C (a boundary line updating process). Similarly in the examples illustrated in FIGS. 4 and 5, the boundary line has been updated.

When the boundary line newly created by the arrangement of the part PTa overlaps the boundary line that has already existed, the boundary lines in an overlapping portion indicated by a broken line in FIGS. 12A to 12C are deleted. If all the boundary lines are deleted, a number YLa1 of the deleted boundary line is blank, and the blank number YLa1 is assigned to the subsequent boundary line newly produced. When the number of the boundary line is thus recycled, a memory can be saved, and a calculation load can be reduced. When the boundary lines are continuous before and after the arrangement of the part PTa, the boundary line XLa1 is extended if boundary conditions match each other, as illustrated in FIG. 12B. On the other hand, in the example illustrated in FIG. 12C, when a boundary condition set for the boundary line XLa1 and a boundary condition set for the boundary line XLa2 do not match each other, the boundary line XLa1 is not extended but a new boundary line XLa2 is produced, although the arrangement is similar to that illustrated in FIG. 12B.

In the above-described procedure, the part arrangement process and the boundary line updating process are repeatedly performed (a first repetition step). If a part boundary condition set for the part PTa and a boundary line boundary condition set for a boundary line cannot match each other, i.e., the first type of part PTa cannot be arranged, the type of part is changed to a second type of part PTb to be arranged next in order (a part type change process).

A part arrangement process, a boundary line updating process, a first repetition process, and a part type change process are repeatedly performed according to an arrangement order described in a command file (a second repetition step). This makes it possible to arrange a plurality of types of parts PT in the arrangement area AC.

Since the parts are automatically arranged using the boundary condition, the number of conditions to be set by the user can be reduced. Moreover, it can be identified that the part has not yet been arranged using not a mesh Ms but the boundary line. Accordingly, a calculation load, including reduction of a memory, may be small While the part PT is repeatedly arranged, deletion and production of the boundary lines XLa and YLa are repeatedly updated, thereby making it possible to significantly more reduce the number of arrangements of the boundary lines than when new boundary lines continue to be produced. This makes it possible to reduce a calculation load including reduction of a memory.

To prevent a circuit from being disconnected, it is desirable to arrange parts without any gap therebetween in the arrangement area AC except for the above-described offset arrangement. On the other hand, if the gap between the parts is made clear after the parts are arranged, a time loss is large if the parts are rearranged. In a method for arranging an adjustment part PTaj, like in the map system already described, an amount of coordinates to be set by the user increases.

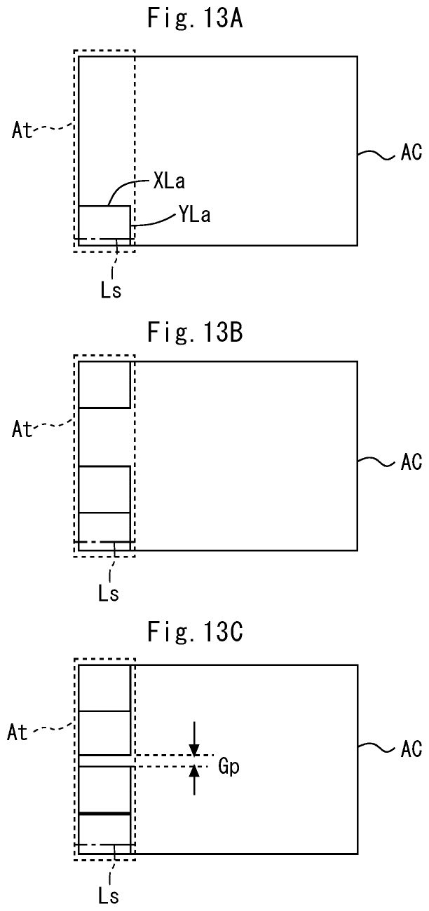

In the present embodiment, a part is provisionally arranged before the part is arranged (a provisional arrangement process). The provisional arrangement of the part means not provisionally arranging the part itself but updating a boundary line assuming that the part has been provisionally arranged, thereby making it possible to more shorten a time period required for the provisional arrangement and reduce a calculation load than when the part itself is provisionally arranged, like in the part arrangement process. To further shorten the time period required for the provisional arrangement, a provisional arrangement area At may be restricted to be smaller than an arrangement area AC, as illustrated in FIGS. 13A to 13C. The provisional arrangement area At may be set to the arrangement area AC to update the boundary line over the entire arrangement area AC.

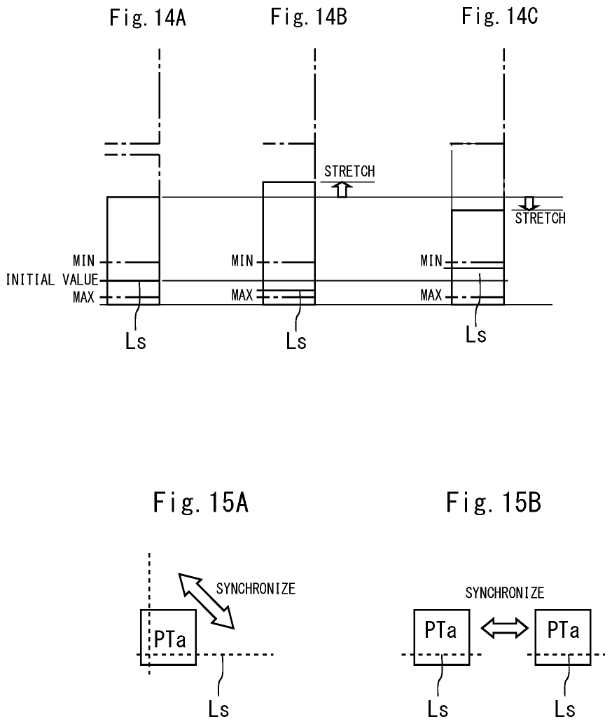

In the provisional arrangement, a gap (gap region) Gp that has occurred by updating boundary lines or its function is found. A stretch line Ls is provided such that the found gap Gp is eliminated, that is, parts are arranged without any gap therebetween. The stretch line Ls is set to the maximum value max side or the minimum value min side from its initial value, as described below, thereby making it possible to stretch the dimensions of each of the parts. The boundary lines are updated assuming that the parts have been provisionally arranged, and the gap Gp immediately before the boundary lines cross each other is set as a stretch dimension. When the stretch line Ls is set to the maximum value max side, as illustrated in FIG. 14B, from the initial value illustrated in FIG. 14A, thereby making it possible to fill in the gap Gp between the parts PTa arranged in the part arrangement process. Contrary to this, the stretch line Ls is set to the minimum value min side, as illustrated in FIG. 14C, thereby making it possible to also widen the gap Gp and arrange another part in the widened gap. The stretch direction is not limited to an up-down direction, but may be a left-right direction or both an up-down direction and the left-right direction. If the stretch direction is both the up-down direction and the left-right direction, a stretch line for up-down direction and a stretch line for left-right direction may be provided. Further, a stretch of the part PTa may be synchronized in the part PTa, as illustrated in FIG. 15A, or may be synchronized between the parts PTa and PTa, as illustrated in FIG. 15B.

As the boundary line updating procedure, a similar procedure to a procedure for the above-described part arrangement can be used. This makes it possible to use the part arrangement procedure at a maximum to update the boundary lines and to enhance versatility. Further, provisional arrangement can be performed without grasping the entire arrangement of the semiconductor chip. Moreover, in the provisional arrangement process, only the boundary lines for the provisional arrangement are updated. Accordingly, information about the parts may not be left. As a result, a calculation load can be reduced.

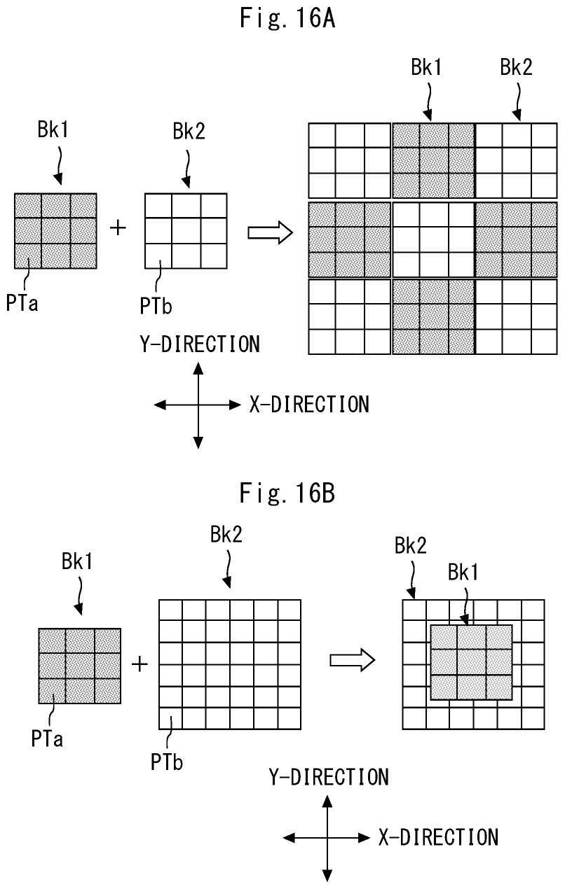

Although a case where the part is arranged in the rectangular arrangement area AC has been described in the present embodiment, the present invention is not limited to this. An example of a power device is a device having a periodic structure, like an IGBT and a diode constituting an RC-IGBT. For example, as illustrated in FIG. 16A, a plurality of blocks Bk1 each having a plurality of parts PTa arranged therein and a plurality of blocks Bk2 each having a plurality of parts PTb arranged therein may be arranged in at least one of the X-direction and the Y-direction. In this case, this can be implemented by arranging the parts PTa and the parts PTb to create each of the block Bk1 and the block Bk2 in the above-described procedure, and then setting boundary conditions in each of the block Bk1 and the block Bk2 again. As illustrated in FIG. 16B, this can be implemented by making a plurality of blocks Bk1 and a plurality of blocks Bk2 overlap each other in a direction perpendicular to the X-direction and the Y-direction a plurality of times and overlaying the plurality of blocks Bk1 and the plurality of blocks Bk2. This makes it possible to create a semiconductor chip in which overlaid and blocked parts are arranged. The sizes of the blocks Bk1 and Bk2 to be provided side by side or made to overlap each other may be the same as or different from each other.

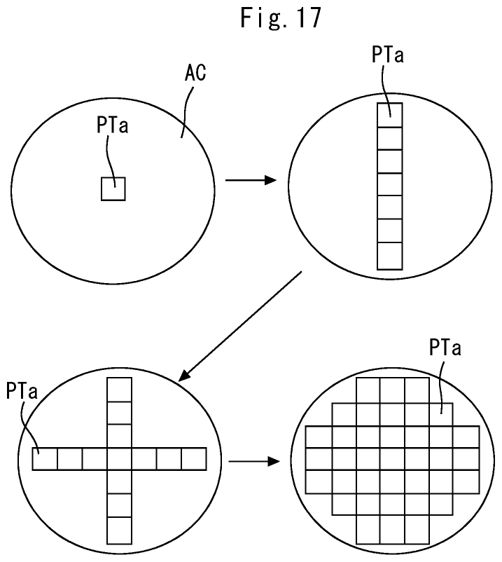

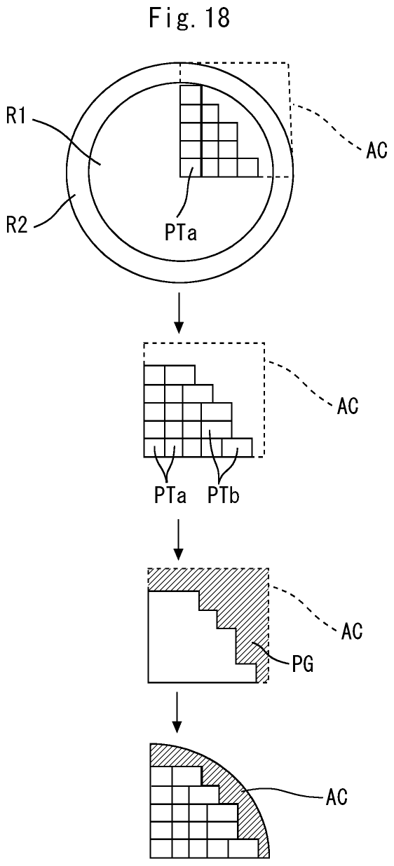

A shape of the arrangement area AC is not limited to a rectangle, but may be a circle like a master mask illustrated in FIG. 17 or a polygon illustrated in FIG. 18, for example. The shape of the arrangement area AC can be described as region setting in a command file. In arrangement in the master mask illustrated in FIG. 17, after two coordinates of a part PTa are arranged at the center of the circle, parts PTa are arranged in a cross shape using one coordinate out of an X-coordinate and a Y-coordinate of the center and one boundary condition, and parts PTa are arranged using two boundary conditions in the remaining portion. In arrangement in a corner portion including a circular arc illustrated in FIG. 18, an arrangement area AC is set to a first quadrant of a circle, and parts PTa of a first type are arranged using two boundary conditions. At this time, the arrangement is limited to a region R1 in the arrangement area AC. The region R1 is a region inside an outer peripheral region R2 having a predetermined length from its peripheral edge. Then, parts PTb of a second type are arranged in the region R1 using two boundary conditions. In the present embodiment, processing up to automatic arrangement of the parts PTa and PTb can be performed. Thereafter, a polygon PG as a blank region excluding the parts PTa and PTb from the arrangement area AC is produced. Finally, a structure using a polygonal shape can be produced by a logical product of the polygon PG and the region R2. Thus, the parts PTa and PTb can be arranged in the arrangement area AC having a complicated shape with which the circular arc or the like is associated. The outer peripheral region R2 has a shape along a boundary line obtained while the parts are arranged. Accordingly, the arrangement area AC cannot be determined before the arrangement. The arrangement area AC may be configured to acquire a shape like a polygon, for example, defined by boundary lines during or after completion of the arrangement of the parts.

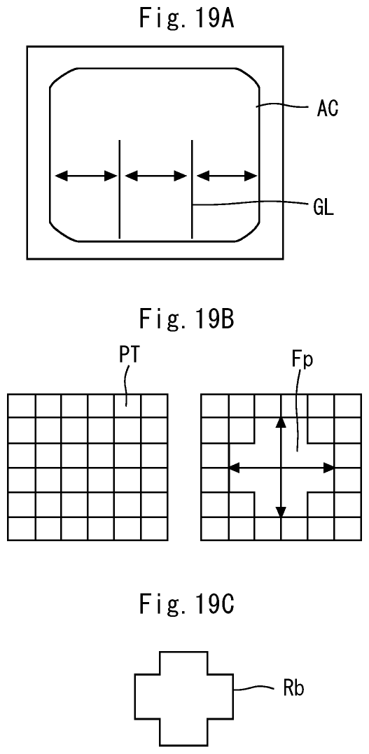

In the power device, a gate liner GL may be arranged such that a cell arrangement region as an arrangement area AC is equally divided, as illustrated in FIG. 19A, to mitigate a switching delay occurring by polysilicon as a gate material for cells such as IGBTs arranged in parallel. The gate liner GL is composed of aluminum and polysilicon, for example. A semiconductor chip has a structure in which a chip surface is covered with a protective film composed of SiO₂ or the like and only a wire bonding portion is exposed to the surface to prevent a wiring from being short-circuited by adhesion of foreign matter. In the power device, the number of wire bondings is large. Accordingly, a protective film Fp has a shape significantly similar to that of a boundary line in the cell arrangement region, as illustrated in FIG. 19B. The protective film Fp, i.e., a wire bonding region as a cell arrangement region can be grasped as a blank region Rb, as illustrated in FIG. 19C, using information about an outline. Although the boundary line in the cell arrangement region cannot be obtained after completion of arrangement of parts PT, the blank region Rb can be grasped by the boundary line during the arrangement. Information required to draw the gate liner GL and the protective film Fp is obtained when the user acquires information about the boundary line immediately before the cells are arranged and reflects the acquired information on a command A function of acquiring the boundary line in the cell arrangement region is preferably formed into a module in the CAD device 1. The module is caused to have a function of drawing a polygon structure after freely offsetting the acquired boundary line in addition to a function of acquiring the information about the boundary line. This makes it possible to output the information about the boundary line in a form of a variable usable as a command file.

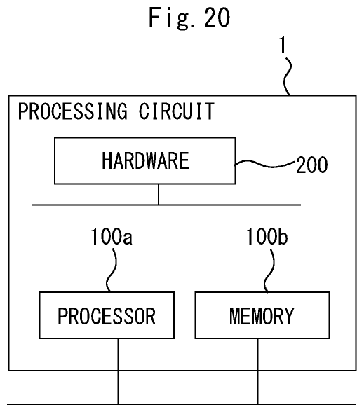

Next, the CAD device 1 that performs a method for automatically arranging parts on a CAD will be described with reference to FIG. 20. FIG. 20 is a hardware configuration diagram of the CAD device 1 that performs the method for automatically arranging parts on a CAD according to the first embodiment. The CAD device 1 corresponds to a computer that can execute a program for automatically arranging parts on a CAD, and can be implemented by a processing circuit. For example, the processing circuit includes at least one processor 100a and at least one memory 100b. For example, the processing circuit includes at least one dedicated hardware 200.

If the processing circuit includes at least one processor 100a and at least one memory 100b, each of functions of an apparatus for automatically arranging parts on a CAD is implemented by software, firmware, or a combination of software and firmware. At least one of the software and the firmware is described as a program. At least one of the software and the firmware is stored in at least one memory 100b. The at least one processor 100a reads out and executes a program stored in the at least one memory 100b. The at least one processor 100a is also referred to as a central processing unit, a processing device, a calculation device, a microprocessor, a microcomputer, or a DSP. Examples of the at least one memory 100b include non-volatile or volatile semiconductor memories such as a RAM, a ROM, a flash memory, an EPROM, and an EEPROM, a magnetic disk, a flexible disk, an optical disk, a compact disk, a mini disk, and a DVD.

If the processing circuit includes at least one dedicated hardware 200, the processing circuit is implemented by a single circuit, a composite circuit, a programmed processor, a parallel-programmed processor, an ASIC, an FPGA, or their combination, for example. For example, each of the functions of the apparatus for automatically arranging parts is implemented by a processing circuit. Some of the functions of the apparatus for automatically arranging parts may be implemented by dedicated hardware 200, and the others may be implemented by software or firmware.

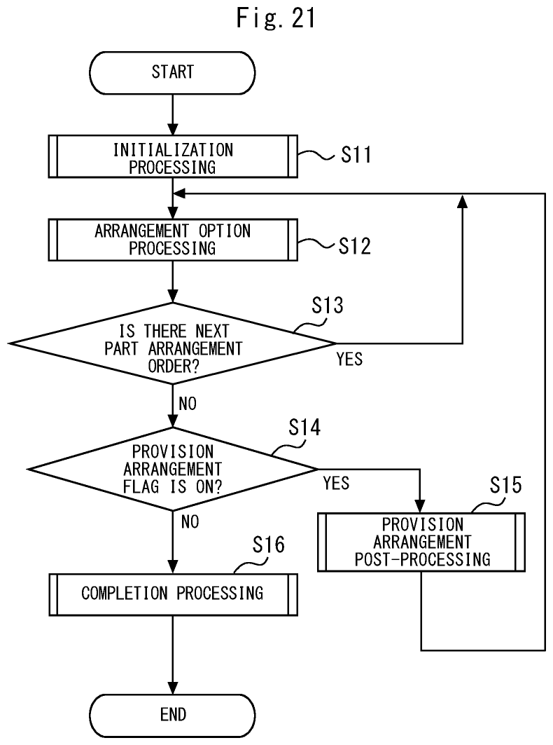

FIG. 21 is a flowchart illustrating main processing of the method for automatically arranging parts on a CAD according to the first embodiment. FIG. 21 illustrates a main operation of the CAD device 1.

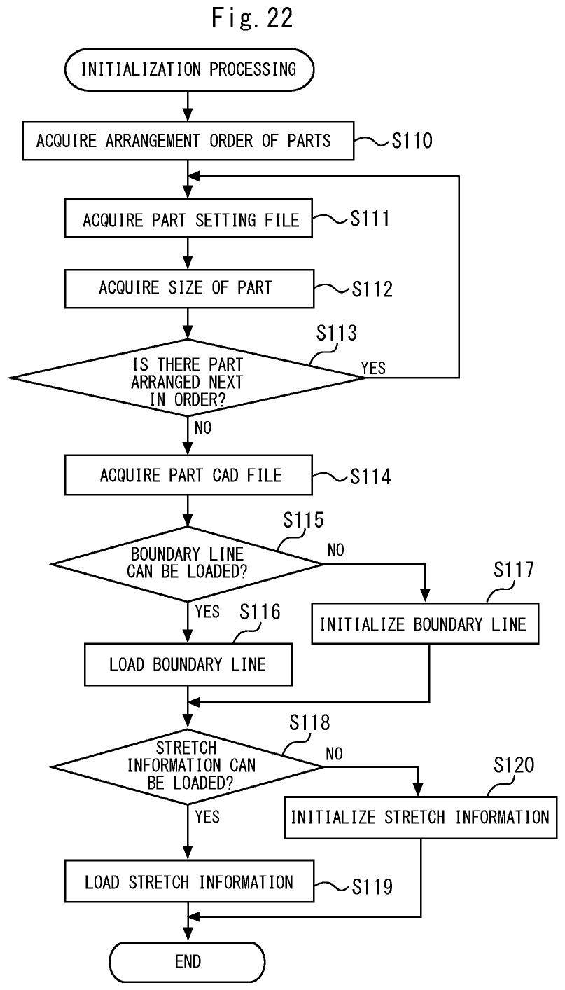

First, in step S11, initialization processing is performed. In the initialization processing, a sub-routine illustrated in FIG. 22 is started up, and an arrangement order of a plurality of types of parts preliminarily prepared by a user is acquired (step S110). Step S110 corresponds to a part arrangement order acquisition process.

Then, a part setting file is acquired (step S111). Step S111 corresponds to a part condition acquisition process. First and second boundary conditions are required to arrange a part PT, and a boundary condition after arrangement of the part PT need not be set.

Then, the size of the part PT is acquired (step S112). The size of the part PT may be obtained by a part outline output function of the CAD device 1. In this case, the user can omit preliminary setting of the size of the part PT. Steps S111 and S112 are repeatedly performed until it is determined in step S113 that there is no part to be arranged next in order, that is, for all types of parts PT.

Then, a part CAD file as a CAD file of the plurality of types of parts is acquired (step S114). Then, it is determined whether or not a boundary line has been stored, and can be loaded (step S115). If the boundary line can be loaded, the boundary line is loaded (step S116). If the boundary line cannot be loaded, the boundary line is initialized (step S117). In the initialization, four boundary lines to be arranged parallel to a dicing line DL as an area termination end line of an arrangement area AC can be set. Then, it is determined whether or not stretch information as information about a stretch of the part has been stored, and can be loaded (step S118). If the stretch information can be loaded, the stretch information is loaded (step S119). If the stretch information cannot be loaded, the stretch information is initialized (step S120).

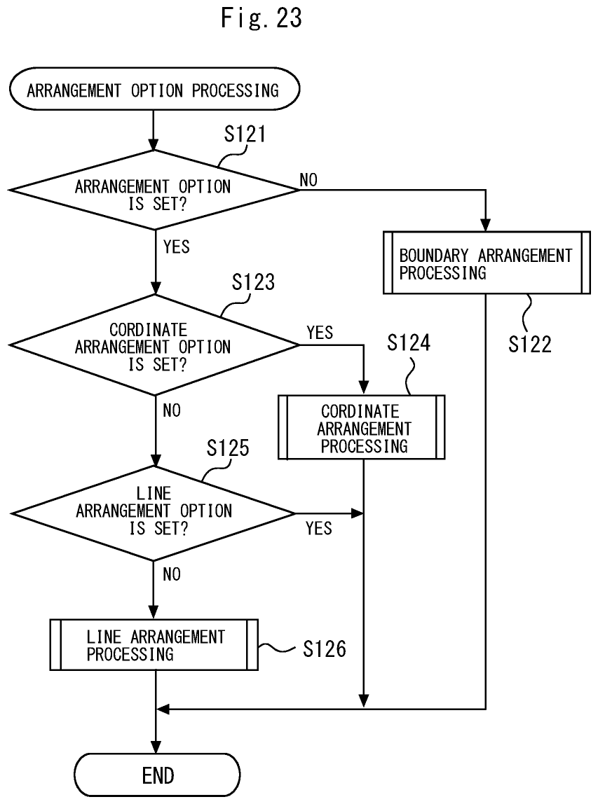

When the initialization processing ends, arrangement option processing is performed (step S12). In the arrangement option processing, a sub-routine illustrated in FIG. 23 is started up, and it is determined whether or not an arrangement option has been set (step S121). If the arrangement option has not been set, boundary arrangement processing is performed (step S122).

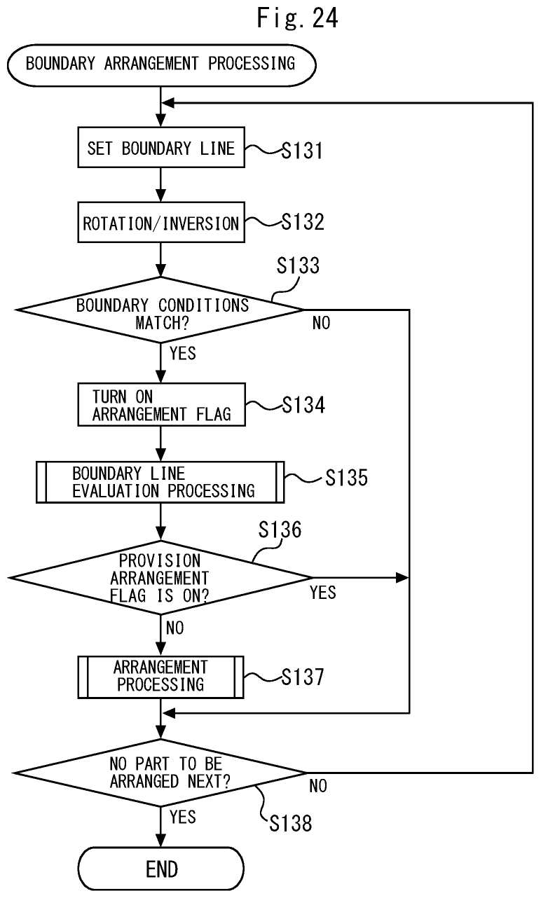

In the boundary arrangement processing, a sub-routine illustrated in FIG. 24 is started up, a boundary line is set (step S131), and rotation/inversion is performed according to a rotation condition (step S132). Then, it is determined whether or not boundary conditions match each other (step S133). If the boundary conditions match each other, an arrangement flag is turned on (step S134). Then, boundary line evaluation processing is performed (step S135).

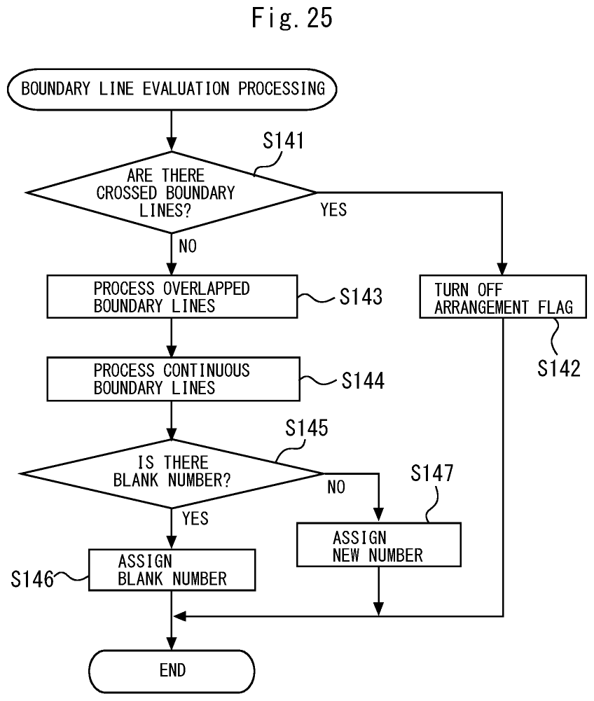

In the boundary line evaluation processing, a sub-routine illustrated in FIG. 25 is started up, and it is determined whether or not there are boundary lines that cross each other (step S141). If there are boundary lines that cross each other, the arrangement flag is turned off (step S142), and the boundary line evaluation processing ends. If there are no boundary lines that cross each other, the boundary lines that overlap each other are processed (step S143), continuous boundary lines are processed (step S144), and it is determined whether or not there is a blank number to be assigned to a boundary line (step S145). If there is a blank number, the boundary line is assigned the blank number (step S146). If there is no blank number, the boundary line is assigned a new number (step S147), and the boundary line evaluation processing ends.

After the boundary line evaluation processing ends, it is determined whether or not the provisional arrangement flag is on (step S136). If the provisional arrangement flag is off, arrangement processing is performed (step S137).

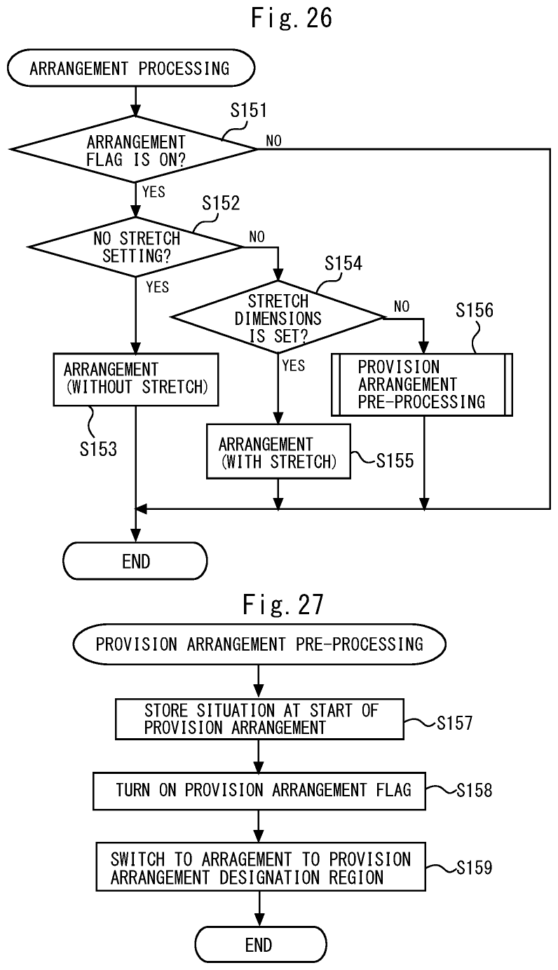

In the arrangement processing, a sub-routine illustrated in FIG. 26 is started up, and it is determined whether or not the arrangement flag is on (step S151). If the arrangement flag is off, the arrangement processing ends. If the arrangement flag is on, it is determined whether or not there is no stretch setting (step S152). If there is no stretch setting, a part is arranged without being stretched (step S153), and the arrangement processing ends. On the other hand, if there is stretch setting, it is determined whether or not stretch dimensions have already been set (step S154). If the stretch dimensions have already been set, the part is stretched and the stretched part is arranged (step S155), and the arrangement processing ends.

When the arrangement processing ends, processing in steps S131 to S137 is repeated until there is no part to be next arranged (step S138).

If it is determined in step S154 described above that the stretch dimensions have not been set, provisional arrangement pre-processing is performed (step S156).

In the provisional arrangement pre-processing, a sub-routine illustrated in FIG. 27 is started up, and a situation occurring when provisional arrangement is started up is stored (step S157), the provisional arrangement flag is turned on (step S158), and the provisional arrangement is switched to arrangement to a provisional arrangement designation region (step S159).

If it is determined in step S136 described above that the provisional arrangement flag is on, the processing proceeds to step S138. In step S138, the part is provisionally arranged according to a similar routine to that in the arrangement of the part. The provisional arrangement of the part is not to provisionally arrange the part itself but to update the boundary line assuming that the part has been provisionally arranged, as described above.

If it is determined in step S121 described above that an arrangement option has been set, it is determined whether or not there is coordinate arrangement option setting (step S123). If there is coordinate arrangement option setting, coordinate arrangement processing is performed (step S124).

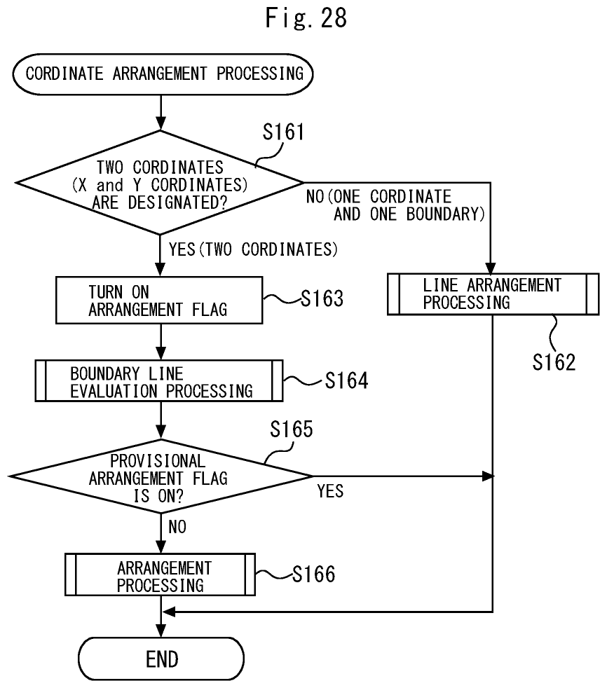

In the coordinate arrangement processing, a sub-routine illustrated in FIG. 28 is started up, and it is determined whether or not two coordinates (X and Y coordinates) have been designated (step S161). If the two coordinates have not been designated, that is, the one coordinate has been set, line arrangement processing is performed (step S162).

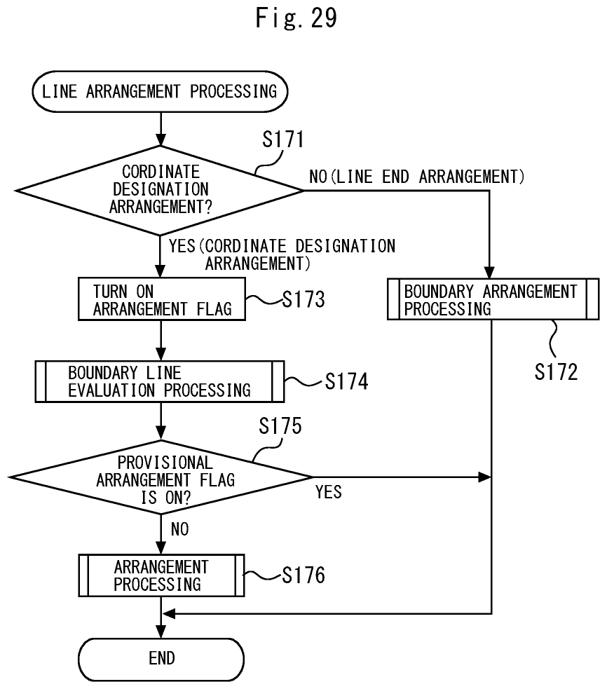

In the line arrangement processing, a sub-routine illustrated in FIG. 29 is started up, and it is determined whether or not an arrangement system is coordinate designation arrangement (step S171). If the arrangement system is not coordinate designation arrangement, that is, is line end arrangement, the above-described boundary arrangement processing is performed (step S172), and the line arrangement processing ends. If the arrangement system is coordinate designation arrangement, the arrangement flag is turned on (step S173), and the above-described boundary line evaluation processing is performed (step S174). Then, it is determined whether or not the provisional arrangement flag is on (step S175). If the provisional arrangement flag is on, the line arrangement processing ends. If the provisional arrangement flag is off, the above-described arrangement processing is performed (step S176), and the line arrangement processing ends.

If it is determined in step S161 described above that the two coordinates have been designated, the arrangement flag is turned on (step S163), and the above-described boundary arrangement processing is performed (step S164). Then, it is determined whether or not the provisional arrangement flag is on (step S165). If the provisional arrangement flag is on, the coordinate arrangement processing ends. If the provisional arrangement flag is off, the above-described arrangement processing is performed (step S166), and the coordinate arrangement processing ends.

When the arrangement option processing ends, it is determined whether or not there is a next part arrangement order (step S13). If there is a next part arrangement order, the processing returns to step S12. On the other hand, if there is no next part arrangement order, it is determined whether or not the provisional arrangement flag is on (step S14). If the provisional arrangement flag is on, provisional arrangement post-processing is performed (step S15).

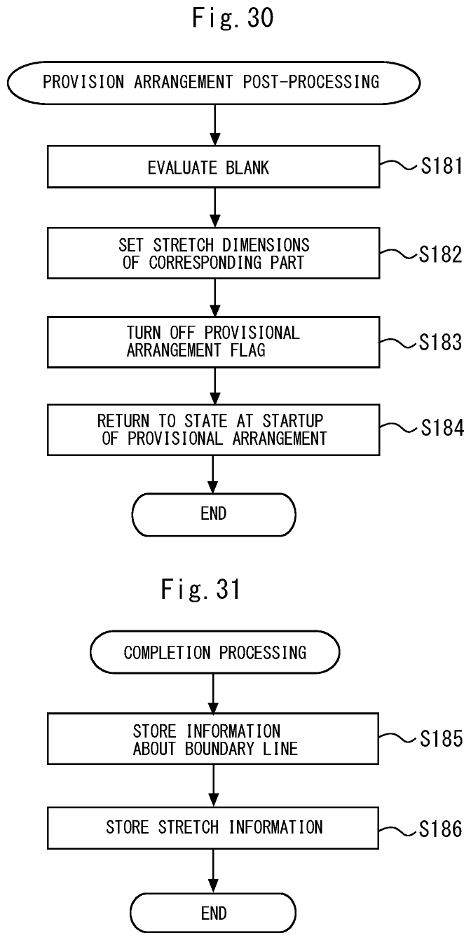

In the provisional arrangement post-processing, a sub-routine illustrated in FIG. 30 is started up, and a gap Gp as a blank after provisional arrangement is evaluated (step S181), stretch dimensions of the corresponding part are set (step S182), and the provisional arrangement flag is turned off (step S183). Then, processing returns to a state at the time of startup of the provisional arrangement (step S184), and the provisional arrangement post-processing ends.

If it is determined in step S14 described above that the provisional arrangement flag is off, completion processing is performed (step S16).

In the completion processing, a sub-routine illustrated in FIG. 31 is started up, information about a boundary line is stored (step S185), and stretch information is stored (step S186). Then, the completion processing ends.

Then, an area termination end line as a line representing a termination end of the arrangement area AC of the semiconductor chip is acquired as a boundary line, and a third boundary condition to be set for the boundary line is acquired (step S114). Step S114 corresponds to the boundary line acquisition process.

According to the present embodiment, the amount of coordinates to be set by the user can be reduced to automatically arrange the part using the boundary condition. Moreover, it can be identified that the part has not yet been arranged using not a mesh Ms but the boundary line. Accordingly, a calculation load, including reduction of a memory, may be small.

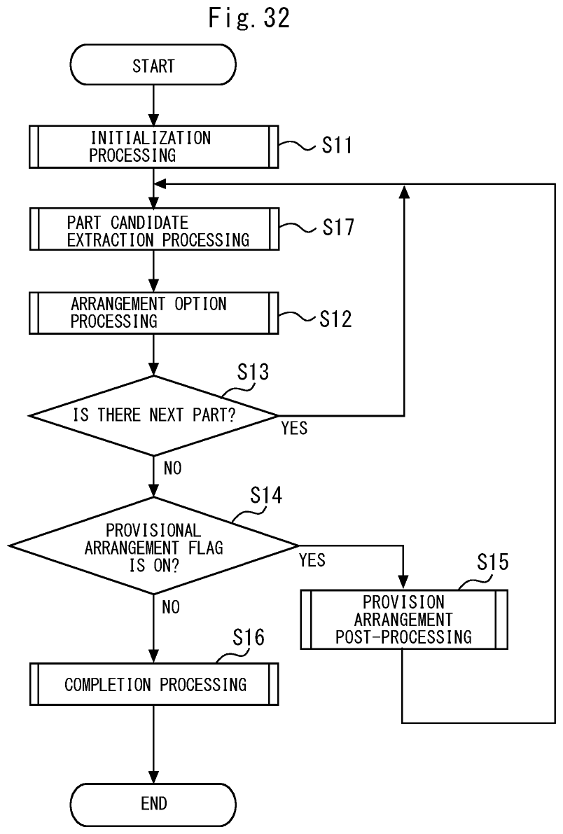

The part arrangement order need not be designated. In this case, as illustrated in FIG. 32, the above-described initialization processing is performed, and part candidate extraction processing is then performed (step S17).

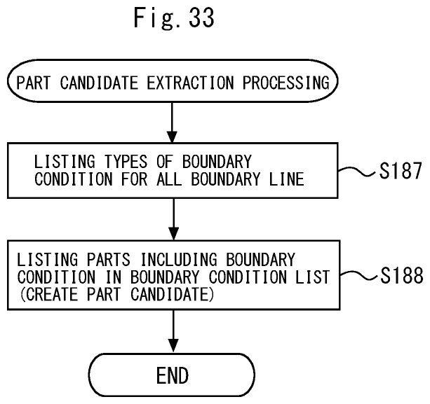

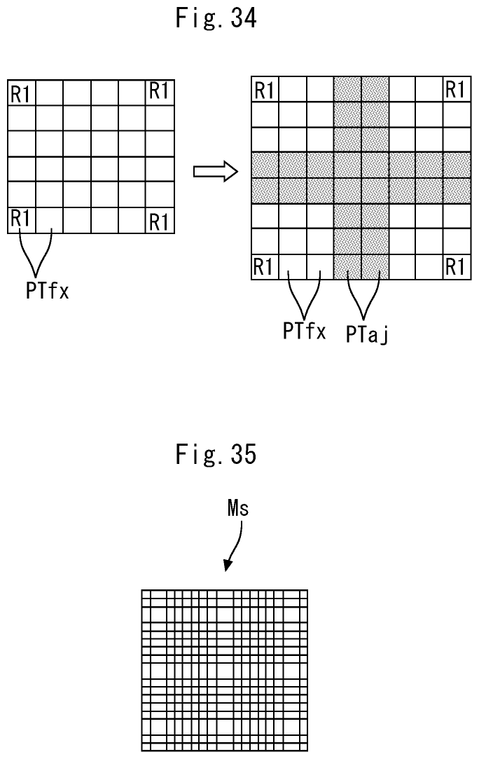

In the part candidate extraction processing, a sub-routine illustrated in FIG. 33 is started up, types of boundary conditions for all boundary lines are listed (step S187), and parts including the boundary conditions in a boundary condition list of the boundary lines are listed (step S188). In step S188, part candidates are created. Then, the above-described arrangement option processing is performed (step S12).

### REFERENCE SIGNS LIST

1 . . . CAD tool, CAD
AC . . . arrangement area
BB, BR, BT, BL . . . first boundary conditions
BC0, BC1, BC2, BC3 . . . second boundary conditions
PT, PTa, PTb . . . parts
Gp . . . gap region, gap
XLp0, YLp1, XLp1, YLp0 . . . sides
C0, C1, C2, C3 . . . corners
Bk1, Bk2 . . . blocks

1. A method for automatically arranging parts on a CAD for automatically arranging a plurality of types of parts in an arrangement area on a CAD tool, two directions perpendicular to each other in the arrangement area being an X-direction and a Y-direction, and the plurality of types of parts being each a rectangle having a side parallel to the X-direction or the Y-direction, the method comprising:
a part condition acquisition step for acquiring a part boundary condition, which is set for each of the types of the parts, representing the type of the part to be permitted to be arranged adjacent to the part;
a part arrangement order acquisition step for acquiring an arrangement order, which is set for each of the types of the parts, of the part in the arrangement area;
a boundary line acquisition step for arranging a boundary line parallel to an area termination end line as a line representing a termination end of the arrangement area in the X-direction or the Y-direction and acquiring a boundary line boundary condition representing the parts arranged in two regions separated by the boundary line;
a part arrangement step for comparing the part boundary condition set for the part and the boundary line boundary condition set for the boundary line arranged in the arrangement area and arranging the part when the conditions match each other;
a boundary line updating step for updating the boundary line and the boundary line boundary condition after arranging the part in the part arrangement step;
a first repetition step for repeatedly performing the part arrangement step and the boundary line updating step;
a part type change step for changing, when the part boundary condition and the boundary line cannot match each other, the type of the part to be arranged to the part to be arranged next in order; and
a second repetition step for repeatedly performing the part arrangement step, the boundary line updating step, the first repetition step, and the part type change step according to the arrangement order.

2. The method for automatically arranging parts on a CAD according to claim 1, further comprising
a provisional arrangement step for updating the boundary line assuming that the part has been arranged before performing the method for automatically arranging parts on a CAD according to claim 1,
wherein the provisional arrangement step includes
a step of performing provisional arrangement by updating the boundary line assuming that the part has been arranged according to the method for automatically arranging parts on a CAD according to claim 1, and
a step of calculating dimensions of a gap region where the provisional arrangement has not been performed from the boundary line after the provisional arrangement and adjusting dimensions of the part such that the gap region is eliminated.

3. The method for automatically arranging parts on a CAD according to claim 1, wherein
the part boundary condition includes a first boundary condition representing the type of the part to be permitted to be arranged adjacent to each of sides of the part, a second boundary condition representing the type of the part to be permitted to be arranged diagonally adjacent to each of corners of the part, and a rotation condition representing a rotational angle to be permitted when the part is arranged, and
the boundary line boundary condition includes a third boundary condition representing presence or absence and the type of the parts arranged in two regions separated by the boundary line or indicating that the two regions are outside of an arrangement area of the part.

4. The method for automatically arranging parts on a CAD according to claim 3, further comprising
in the part arrangement step, comparing the first boundary condition and the second boundary condition for the part with the third boundary condition for the boundary line, and arranging, when the first boundary condition for two sides of the part and the third boundary condition for the two boundary lines match each other, the part to contact the two boundary lines that match each other or arranging, when the second boundary condition for the part and the third boundary condition for the two boundary lines match each other, the part to contact a vertex formed by the two boundary lines that match the corner of the part, and
in the boundary line updating step, deleting the boundary line that overlaps the side of the arranged part and setting, on the side of the part that does not overlap the boundary line, the new boundary line and the third boundary condition.

5. The method for automatically arranging parts on a CAD according to claim 1,
wherein a plurality of blocks each having the parts arranged therein according to the method for automatically arranging parts on a CAD according to claim 1 are arranged in at least one of an X-direction and a Y-direction, or the plurality of blocks are arranged to overlap one another in a direction perpendicular to the X-direction and the Y-direction.

6. The method for automatically arranging parts on a CAD according to claim 1, wherein the arrangement area has a polygonal shape.

7. The method for automatically arranging parts on a CAD according to claim 6, wherein the polygonal shape is defined by the boundary line during or after completion of arrangement of the part.

8. The method for automatically arranging parts on a CAD according to claim 1, wherein the part boundary condition is automatically set from arrangement data of the part created in the past.

9. A program for automatically arranging parts on a CAD for automatically arranging a plurality of types of parts in an arrangement area on a CAD tool, two directions perpendicular to each other in the arrangement area being an X-direction and a Y-direction, and the plurality of types of parts being each a rectangle having a side parallel to the X-direction or the Y-direction, the program causing a computer to perform:
a part condition acquisition step for acquiring a part boundary condition, which is set for each of the types of the parts, representing the type of the part to be permitted to be arranged adjacent to the part;
a part arrangement order acquisition step for acquiring an arrangement order, which is set for each of the types of the parts, of the part in the arrangement area;
a boundary line acquisition step for arranging a boundary line parallel to an area termination end line as a line representing a termination end of the arrangement area in the X-direction or the Y-direction and acquiring a boundary line boundary condition representing the parts arranged in two regions separated by the boundary line;
a part arrangement step for comparing the part boundary condition set for the part and the boundary line boundary condition set for the boundary line arranged in the arrangement area and arranging the part when the conditions match each other;
a boundary line updating step for deleting the boundary line that overlaps a side of the part arranged in the part arrangement step and setting the new boundary line and the boundary line boundary condition on the side of the part that does not overlap the boundary line;
a first repetition step for repeatedly performing the part arrangement step and the boundary line updating step;
a part type change step for changing, when the part boundary condition and the boundary line cannot match each other, the type of the part to be arranged to the part to be arranged next in order; and
a second repetition step for repeatedly performing the part arrangement step, the boundary line updating step, the first repetition step, and the part type change step according to the arrangement order.
